(19) United States
(12) Patent Application Publication
(10) Pub. No.: US 2016/0129953 A1
(43) Pub. Date: May 12, 2016

(54) MULTI-WHEEL SINGLE OPERATOR TRANSPORT PLATFORM

(71) Applicant: C. JOHNSON INDUSTRIES, LLC, Minneapolis, MN (US)

(72) Inventor: Carl Walter Johnson, Minneapolis, MN (US)

(21) Appl. No.: 14/995,905

(22) Filed: Jan. 14, 2016

Related U.S. Application Data
(63) Continuation-in-part of application No. PCT/US2014/042255, filed on Jun. 13, 2014.
(60) Provisional application No. 61/847,311, filed on Jul. 17, 2013.

(51) Int. Cl. B62D 51/02; B62D 51/00; B60K 7/00; B60K 1/02

(52) U.S. Cl. CPC B62D 51/02; B60K 1/02; B62D 51/001; B60K 7/0007

(57) ABSTRACT

An electrical self-controlled people mover, method of manufacturing, and method of operation are described. The people mover includes a base portion and a handle portion. The base portion includes a frame, a platform fixed to the frame, the platform having a support surface for supporting an operator standing thereon, and a set of front wheels and a set of rear wheels, one of the front or rear wheels being connected to an electric motor for each of the front or rear wheels, the electronic motors for powering the electrical self-controlled individual people mover. The handle portion includes a handle bar for the operator to hold on to, a support shaft removably fixed to the shaft, the support shaft extending between the support surface of the platform and the handle bar, and an electronic controller for navigating the people mover.

### FIELD

This disclosure relates generally to a multi-wheel people mover. More specifically, the disclosure relates to a multi-wheel people mover including a platform on which a person can stand during transport in various directions, e.g., backward, forward, turning, or the like.

### BACKGROUND

People movers have existed for a number of years. One particular example is a people mover including two large wheels that uses a gyroscope so that an operator leans forward, backward, right, or left in order to move the people mover in various directions. Such a people mover is available from companies such as Segway Incorporated. People movers have shown to be popular for people who would like to tour or trek without, for example, walking or riding a bike. Such a people mover, however, can be difficult for the average operator to use their body position to control when traveling in various directions, particularly when traveling in an area including uphill and/or downhill terrain.

### SUMMARY

This disclosure relates generally to a multi-wheel people mover. More specifically, the disclosure relates to a multi-wheel people mover including a platform on which a person can stand during transport in various directions, e.g., backward, forward, turnaround, or the like.

An electrical self-controlled people mover can include a set (e.g., two) of front wheels and a set (e.g., two) of rear wheels fixed to a frame which supports a platform on which an operator can stand.

In some embodiments, the electrical self-controlled people mover can include one or more headlights. In such embodiments, the lights can be mounted near the front wheels such that the lights illuminate the path toward the front of the electrical self-controlled people mover.

In some embodiments, the electrical self-controlled people mover can be operated with a joystick. The joystick can, for example, be used to direct the people mover in a variety of directions, e.g., forward, backward, left-turns, right-turns, or combinations thereof. In some embodiments, the joystick can include one or more additional controls such as, but not limited to, a power switch controller, a speed controller, a headlight controller, or the like.

In some embodiments, the electrical self-controlled people mover can be disassembled for transport. In such embodiments, the support shaft and handle bar can be separated from the base portion and each portion can be separately transportable.

In some embodiments, the electrical self-controlled people mover can be reconfigured for transport. In such embodiments, the support shaft can be multiple pieces and can hinge via a hinge assembly such that the handle bar portion can be folded into a transport configuration.

An electrical self-controlled people mover is described. The people mover includes a base portion, a handle portion, and an electronic controller for navigating the people mover. The base portion includes a frame, a platform fixed to the frame, the platform having a support surface for supporting an operator standing thereon, a set of front wheels and a set of rear wheels, the front and rear wheels being disposed under the platform relative to a transport surface, and a shaft extending away from the transport surface. The handle portion includes a handle bar for the operator to hold on to and a support shaft removably fixed to the shaft, the support shaft extending between the support surface of the platform and the handle bar.

A method of manufacturing an electrical self-controlled people mover is described. The method includes providing a base portion including a frame, a platform fixed to the frame, the platform having a support surface for supporting an operator standing thereon, a set of front wheels and a set of rear wheels, the front and rear wheels being disposed under the platform relative to a transport surface, and a shaft extending away from the transport surface. The method further includes providing a handle portion including a handle bar for the operator to hold on to and a support shaft removably fixed to the shaft, the support shaft extending between the support surface of the platform and the handle bar. The method further includes fixing an electronic controller for navigating the people mover.

A method of operating an electrical self-controlled people mover is described. The method includes stepping onto a platform of the people mover in a vertical standing position; grasping a handle bar, the handle bar being removably fixed to a base portion of the people mover; turning on an on/off switch controller on an electronic controller which is mounted to the handle bar; setting a speed controller to a desired speed; and moving a joystick to control a transport path of the people mover.

An electrical self-controlled individual people mover is described. The electrical self-controlled individual people mover includes a base portion and a handle portion. The base portion includes a frame, a platform fixed to the frame, the platform having a support surface for supporting an operator standing thereon, and a set of front wheels and a set of rear wheels, one of the front or rear wheels being connected to an electric motor for each of the front or rear wheels, the electronic motors for powering the electrical self-controlled individual people mover. The handle portion includes a handle bar for the operator to hold on to, a support shaft removably fixed to the shaft, the support shaft extending between the support surface of the platform and the handle bar, and an electronic controller for navigating the people mover.

A method of manufacturing an electrical self-controlled individual people mover is described. The method includes providing a base portion including a frame, a platform fixed to the frame, the platform having a support surface for supporting an operator standing thereon, and a set of front wheels and a set of rear wheels, one of the front or rear wheels being connected to an electric motor for each of the front or rear wheels, the electronic motors for powering the electrical self-controlled individual people mover. The method further includes providing a handle portion including a handle bar for the operator to hold on to, a support shaft removably fixed to the shaft, the support shaft extending between the support surface of the platform and the handle bar. The method also includes fixing an electronic controller for navigating the people mover.

### BRIEF DESCRIPTION OF THE DRAWINGS

References are made to the accompanying drawings that form a part of this disclosure, and which illustrate the embodiments in which the systems and methods described in this specification can be practiced.

FIG. 1 illustrates a side view of a people mover, according to some embodiments.

FIG. 2 illustrates a sectional view of the people mover of FIG. 1, according to some embodiments.

FIG. 3 illustrates a front view of the people mover of FIG. 1, according to some embodiments.

FIG. 4 illustrates a top view of the people mover of FIG. 1, according to some embodiments.

FIG. 5 illustrates a side view of a people mover, according to some embodiments.

FIG. 6 illustrates a partial side view of the people mover of FIG. 5, according to some embodiments.

FIG. 7 illustrates a perspective view of the people mover of FIG. 5, according to some embodiments.

FIG. 8 illustrates a side view of the people mover of FIG. 5, according to some embodiments.

FIG. 9 illustrates a front view of the people mover of FIG. 5, according to some embodiments.

FIG. 10 illustrates a rear view of the people mover of FIG. 5, according to some embodiments.

Like reference numbers represent like parts throughout.

### DETAILED DESCRIPTION

This disclosure relates generally to a multi-wheel people mover. More specifically, the disclosure relates to a multi-wheel people mover including a platform on which a person can stand during transport in various directions, e.g., backward, forward, turnaround, or the like.

A people mover is described that allows for an operator to stand during transport. The people mover does not require a gyroscope. In some embodiments, the people mover can be used by, for example, but not limited to, a family member, friend, or third party (such as, but not limited to, medical staff, law enforcement personnel, or the like) to stand on the platform and travel along with a physically challenged person who is operating a comparable electrical wheel-chair system.

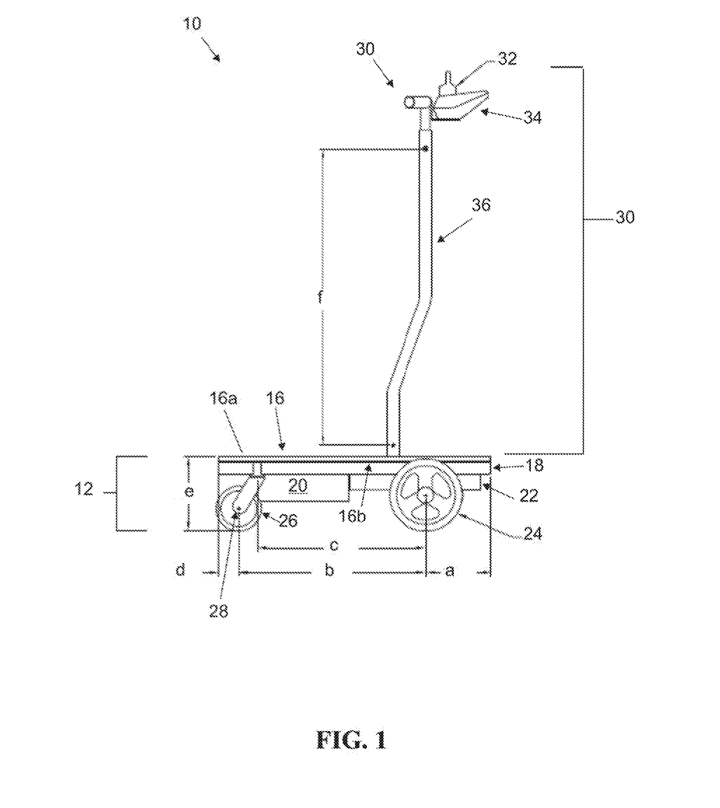

FIG. 1 illustrates a side view of a people mover 10, according to some embodiments. The people mover 10 includes a base portion 12 and a handle portion 14.

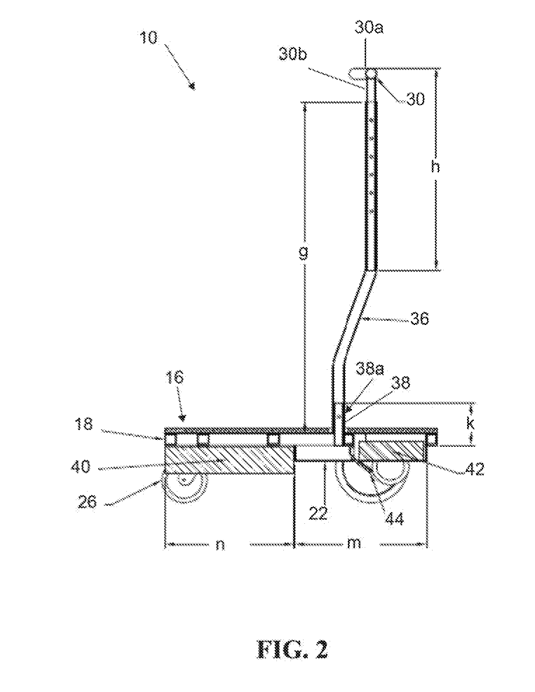

The base portion 12 includes a platform 16. The platform 16 is fixed to a frame 18. A battery 20 is fixed to the frame 18. A housing 22 is fixed to the frame 18. A set of front wheels 24 and a set of rear wheels 26 are fixed to the frame 18. It is to be appreciated that the front wheels 24 and the rear wheels 26 can be indirectly fixed to the frame 18. For example, the rear wheels 26 are fixed to the frame 18 by a set of rear wheel mounts 28. With reference to FIG. 2, the base portion 12 also includes a shaft 38 for receiving the handle portion 14.

Returning to FIG. 1, an operator can stand on a top surface 16a of the platform 16 while operating the people mover 10. In some embodiments, the platform 16 can include a shock absorbing device such as, but not limited to, a shock, an airbag, or the like. In some embodiments, the shock absorbing device can provide a smoother ride for the operator. In some embodiments, the shock absorbing device can be adjustable to vary the stiffness of the ride. At least a portion of the bottom surface 16b of the platform 16 is in contact with and/or fixed to the frame 18. The platform 16 can be fixed to the frame 18 using any suitable connection type. Examples of suitable connection types include, but are not limited to, screws, nuts and bolts, adhesives, rivets, welded connections, or the like, along with suitable combinations thereof.

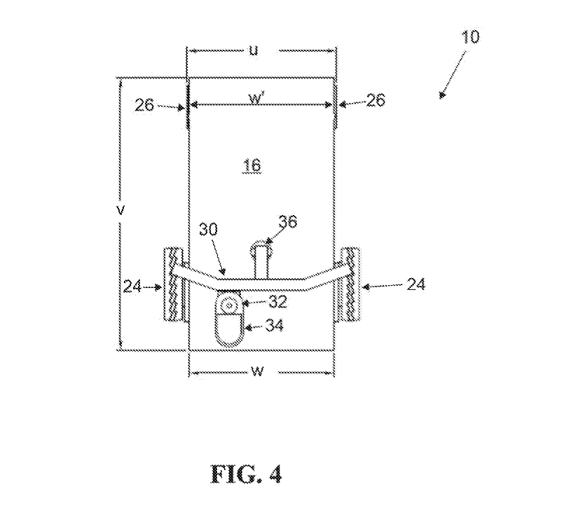

With reference to FIG. 4, the platform 16 has a length v and a width w. In some embodiments, the platform 16 can be substantially rectangular. The rear wheels 26 extend across a width u, which can be larger in some embodiments than the width w of the platform 16. In another embodiment, the width u and the width w can be substantially the same. In yet another embodiment, the width u can be smaller than the width w of the platform 16. In some embodiments, the width w of the platform 16 can decrease over the length v of the platform 16, resulting in a width w′ of the rear portion of the platform 16 which is smaller than the width w at the front portion of the platform 16.

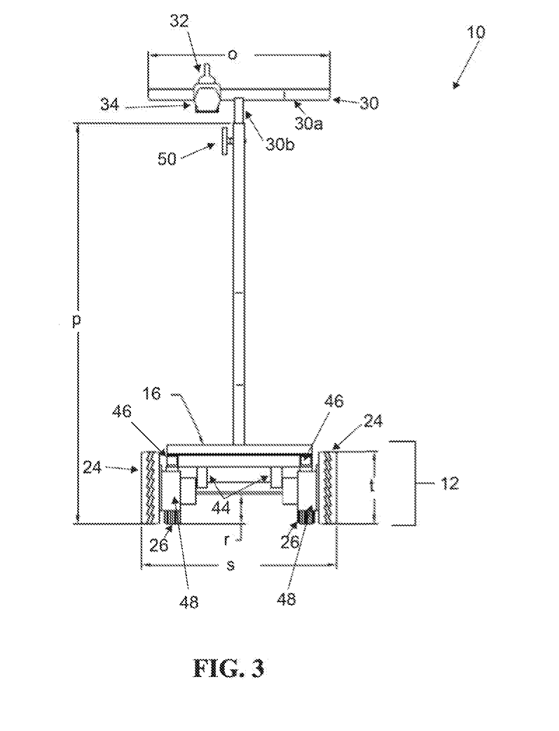

Returning to FIG. 1, the front wheels 24 are fixed to the frame 18 a distance a from the front of the frame 18. The front wheels 24 are a distance b from the rear wheels (as measured from about a center of the front wheels 24 to about a center of the rear wheels 26). The distance b can be based on a variety of factors such as, but not limited to, a diameter of the front wheels 24, a diameter of the rear wheels 26, a length of the platform 16, or the like, along with suitable combinations thereof. As illustrated, in some embodiments, the rear wheel mount 28 can be fixed to the frame 18 at a location that is different from the center of the rear wheels 26. Accordingly, a distance c represents a distance between about the center of the front wheels 24 and the location at which the rear wheel mount 28 is fixed to the frame 18. In some embodiments, the distance c can be smaller than the distance b. A distance d between about the center of the rear wheels 26 and a rear of the frame can be slightly less than a diameter of the rear wheels 26, according to some embodiments. A distance e represents the distance from about the bottom edge of the rear wheels to about the upper surface 16a of the platform. With reference to FIG. 3, a distance t, which represents a diameter of the front wheels 24, can be larger than the distance e (FIG. 1).

Returning to FIG. 1, the handle portion 14 includes a handle bar 30 and a support shaft 36. The handle portion 14 is fixed to the base portion 12 via the shaft 38 (FIG. 2). According to some embodiments, the handle portion 14 is fixed to the base portion 12 such that the handle portion 14 can be removed from the base portion 12. This can, for example, allow the operator, or another party, to remove the handle portion 14 from the base portion 12 in order to more easily transport the people mover 10. It is to be appreciated that a variety of connection types may be suitable. Examples include, but are not limited to, a pin and clip, a button projecting from the shaft 38 that is insertable into an aperture 38a of the support shaft 36, or the like.

An electronic controller 34 is fixed to the handle bar 30. The electronic controller 34 can include one or more controls (e.g., a power switch controller, a speed controller, a headlight controller, a horn, or the like) and a joystick 32. The joystick 32 can be used by the operator to navigate the people mover 10, e.g., direct the people mover 10 in a desired direction. With reference to FIG. 4, the electronic controller 34 can be fixed to one side of the handle bar 30 (e.g., a right side for right-handed people, or a left side for left-handed people). In another embodiment, the electronic controller 34 can be fixed in about the middle of the handle bar 34 (e.g., at about the middle of the distance o).

With reference to FIG. 2, the support shaft 36 can have a height g. The support shaft 36, as illustrated, can be configured such that the lower portion of the support shaft 36 is located farther toward the rear of the base portion 12 than the upper portion of the support shaft 36. The handle bar 30 has a portion 30a which an operator can grasp and a portion 30b that is insertable into the support shaft 36. The portion 30a and the portion 30b are fixed to each other at an angle of about 90 degrees, though the angle can be varied in some embodiments. The handle bar 30 has a length h. The handle bar 30 can be fixed within the support shaft 36 in order to adjust the handle bar 30 height based on a height of the operator. With reference to FIG. 3, a height locker 50 can be used to fix the handle bar 30 relative to the support shaft 36. It is to be appreciated that the support shaft 36 can be insertable into the handle bar 30 in some embodiments. The portion 30a of the handle bar 30 has a width o.

Returning to FIG. 2, the housing 22 includes a controller 42. The controller 42 receives power from the battery 20. It is to be appreciated that the controller 42 can have a separate battery in some embodiments. The controller 42 receives input from the electronic controller 34 and accordingly provides a signal to electric motors 48. The electric motors 48 are discussed in additional detail in accordance with FIG. 3 below. Support members 44 are fixed to the electric motors 48. The housing 22 has a length m, which can be about the same as a length n of the battery 20.

The shaft 38 has a length k such that at least a portion extends above the platform 16. In some embodiments, the shaft 38 includes a button 38a which is insertable into an aperture of the support shaft 36 in order to connect the handle portion 14 to the base portion 12. It is to be appreciated that another method of fixing the handle portion 14 to the base portion 12 may be possible. For example, the support shaft 36 can be bolted to the shaft 38 in some embodiments.

FIG. 3 illustrates a front view of the people mover 10 of FIG. 1, according to some embodiments. Headlights 46 are included with the base portion 12. The headlights 46 can be turned on or turned off via the controller 34, according to some embodiments. In another embodiment, the headlights 46 can be configured so that any time the people mover 10 is powered on, the headlights 46 are turned on and accordingly turned off any time the people mover 10 is powered off. It is to be appreciated that there can be one or more other lights on the people mover 10 such as, but not limited to, a brake light, a turn signal, or the like.

A width s, measured from about a widest point of each of the front wheels 24 is generally the widest part of the base portion 12. In some embodiments, the width s can be the widest part of the people mover 10.

Each of the wheels 24 is rotatably fixed to an electric motor 48. The electric motors 48 receive power from the battery 20 in order to propel the operator in a selected direction. Accordingly, the electric motors 48 are in communication with the controller 42 (FIG. 2). The electric motors 48 are individually controllable such that each of the front wheels 24 can be operated individually in order to, for example, turn the people mover 10. The electric motors 48 can be variable speed motors such that an operator of the people mover 10 can select a speed for the people mover 10 during transit. The electric motors 48 are fixed to the frame 18 and fixed to the support members 44. A rear of the frame 18 is generally a region of the frame 18 that has the lowest ground clearance, and is indicated by the height r. In some embodiments, the height r is smaller than the distance t.

The rear wheels 26 generally provide additional stability for the people mover 10. In some embodiments, the rear wheels 26 can include electric motors similar to the electric motors 48 which power the front wheels 24. In such embodiments, a user can have relatively higher power and may be able to, for example, travel at higher speeds. Further, in such embodiments, the operator may have relatively more control when all four wheels are driven by electric motors.

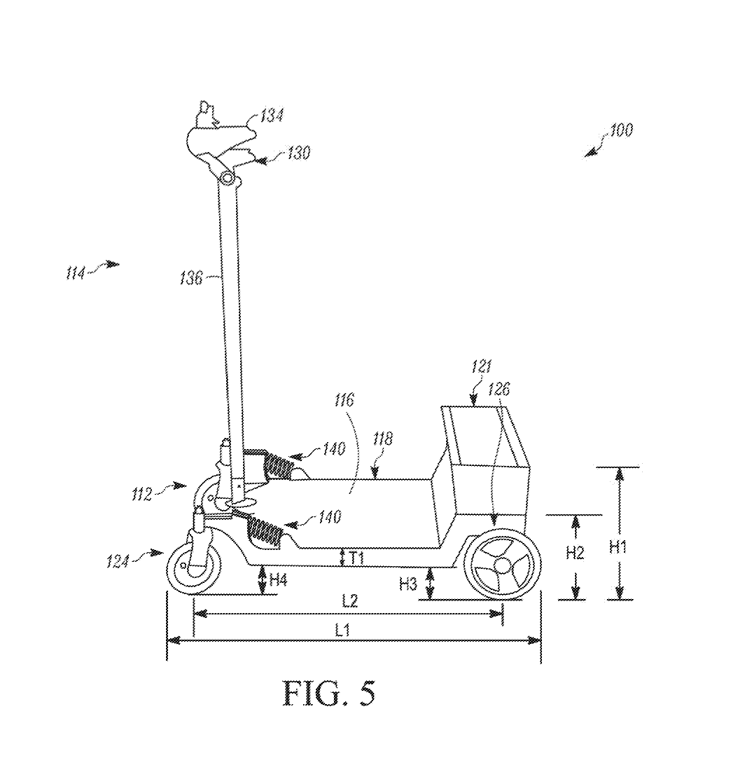

FIG. 5 illustrates a side view of a people mover 100, according to some embodiments. The people mover 100 includes a base portion 112 and a handle portion 114.

The base portion 112 includes a platform 116. The platform 116 is fixed to a frame 118. A battery (not shown in FIG. 5) is fixed to the frame 118 within a battery box 121. A set of front wheels 124 and a set of rear wheels 126 are fixed to the frame 118. It is to be appreciated that the front wheels 124 and the rear wheels 126 can be indirectly fixed to the frame. For example, the rear wheels 126 can be fixed to the frame 118 by a set of rear wheel mounts or the like. The frame 118 has a thickness T1. In some embodiments, the thickness T1 can be at or about 2 inches. It will be appreciated that this number is an example and that the thickness T1 can vary beyond the stated value. In some embodiments, the thickness T1 may be selected based upon an intended weight of the operator. Additionally, this can be balanced with, for example, maintaining a relatively lightweight people mover 100. In some embodiments, the frame 118 can be made of a metal such as, but not limited to, aluminum or the like.

A ground clearance (e.g., a height between a bottom of the frame 118 and the ground) can be, in some embodiments, different at a front of the people mover 100 than at the rear of the people mover 100. For example, a ground clearance H3 at the rear of the people mover 100 can be less than a ground clearance H4 at a front of the people mover 100. In some embodiments, the ground clearances H3 and H4 can be the same. In some embodiments, the ground clearance H3 can be between about 2 inches and about 4 inches. In some embodiments, the ground clearance H4 can be between about 2.5 inches and about 4.5 inches. In some embodiments, the ground clearance H3 can be at or about 2.25 inches and the ground clearance H4 can be at or about 2.75 inches. It will be appreciated that these numbers are examples and that the ground clearances H3 and H4 can vary beyond the stated values. In some embodiments, the ground clearance H3 and H4 can be different when the operator is not standing on the platform 116 and substantially similar when the operator is standing on the platform 116. It will be appreciated that the ground clearances H3 and H4 may be modified based on, for example, particular wheels selected for the front wheels 124 and the rear wheels 126. In some embodiments, the ground clearances H3 and H4 combined with the thickness T1 can be selected such that the operator can step onto the platform 116 without raising his or her foot very high off the ground.

An operator can stand on the platform 116 while operating the people mover 100. The platform 116 includes a set of shock absorbing devices 140. In the illustrated embodiment, the shock absorbing devices 140 include a spring. It will be appreciated that the shock absorbing devices 140 can alternatively include a shock, an airbag, or the like. In some embodiments, the shock absorbing devices 140 can provide a smoother ride for the operator. In some embodiments, the shock absorbing devices 140 may be adjustable to vary a stiffness of a ride for the operator of the people mover 100. It will be appreciated that in some embodiments the rear wheels 126 can also include a shock absorbing device. The platform 116 is fixed to the frame 118. The platform 116 can be fixed to the frame 118 using any suitable connection type. Examples of suitable connection types include, but are not limited to, screws, nuts and bolts, adhesives, rivets, welded connections, or the like.

The front wheels 124 are fixed to a front of the frame 118. The front wheels 124 are a distance L2 from the rear wheels 126 (as measured from about a center of the front wheels 124 to about a center of the rear wheels 126). The distance L2 can be based on a variety of factors such as, but not limited to, a diameter of the front wheels 124, a diameter of the rear wheels 126, a length of the platform 116, or the like, along with suitable combinations thereof. For example, the distance L2 between the front wheels 124 and the rear wheels 126 can be based on a desired total length L1 of the people mover 100. The total length L1 of the people mover 100 can be selected for a variety of reasons such as, but not limited to, accommodating an operator comfortably, or the like. In some embodiments, the total length L1 can be between about 36 inches and about 38 inches. In some embodiments, the length L2 can be between about 30 inches and about 32 inches. In some embodiments, the total length L1 can be at or about 36.5 inches and the length L2 can be at or about 30 inches. It will be appreciated that these numbers are examples and that the lengths L1 and L2 can vary beyond the stated value.

The battery box 121 can be used, in some embodiments, to provide the operator of the people mover 100 with a place to sit. In some embodiments, the battery box 121 can be connected to the frame 118 via a hinge so that the battery box 121 is rotatable when, for example, accessing a battery. The battery for powering the people mover 100 can be disposed within the battery box 121. A height H1 from the ground to a top of the battery box 121 can be, for example, between about 14 inches and about 18 inches. In some embodiments, the height H1 can be at or about 14 inches. It will be appreciated that this number is an example and that the height H1 can vary beyond the stated value. At the rear of the people mover 100, the frame 118 has a height H2 from the around. In some embodiments, the height H2 can be between about 9.75 inches and about 12.75 inches. In some embodiments, the height H2 can be at or about 9.75 inches. It will be appreciated that this number is an example and that the height H2 can vary beyond the stated value. Accordingly, the battery box 121 has a height that is a difference in height between H1 and H2.

The handle portion 114 includes a handle bar 130 and a support shaft 136. The handle portion 114 is fixed to the base portion 112. According to some embodiments, the handle portion 114 can be fixed to the base portion 112 such that the handle portion 114 can be removed from the base portion 112. This can, for example, allow the operator, or another party, to remove the handle portion 114 from the base portion 112 in order to, for example, more easily transport the people mover 100. It is to be appreciated that a variety of connection types may be suitable. In some embodiments, a length of the support shaft 136 can be selected such that a height of the handlebars 130 from the platform 116 is suitable for the operator. For example, the length of the support shaft 136 can be selected so that the handlebars 130 are a height between at or about 34 inches and at or about 46 inches. It will be appreciated that these numbers are examples and that the range can vary beyond the stated values. In some embodiments, the height of the handlebars 130 may be adjustable.

An electronic controller 134 is fixed to the handle bar 130. The electronic controller 134 can include one or more controls (e.g., a power switch controller, a speed controller, a headlight controller, a horn, or the like) and a joystick. The joystick can be used by the operator to navigate the people mover 100, e.g., direct the people mover 100 in a desired direction. The electronic controller 134 can be fixed to one side of the handle bar 30 (e.g., a right side for right-handed people, or a left side for left-handed people. In some embodiments, the electronic controller 134 can be fixed in about the middle of the handle bar 134.

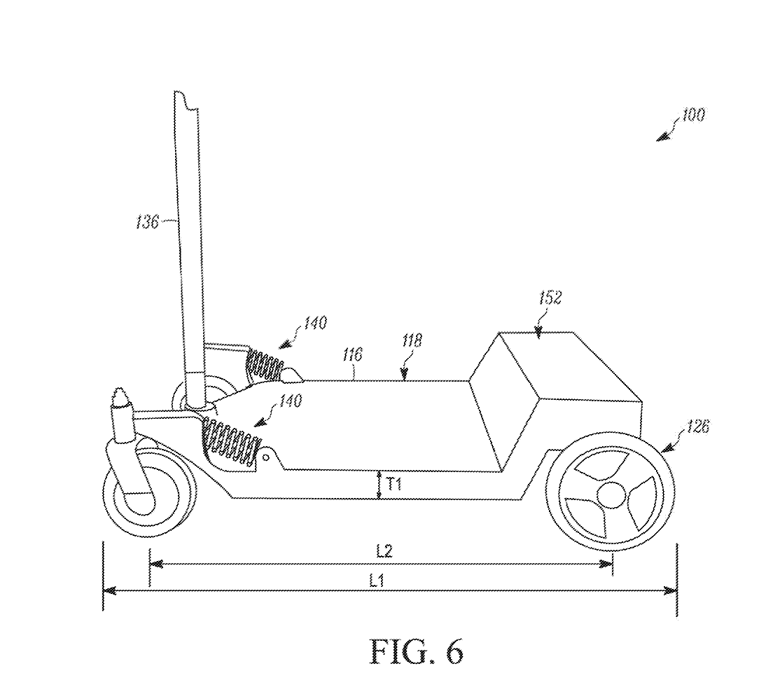

FIG. 6 illustrates a partial side view of the people mover 100 of FIG. 5, according to some embodiments. In the illustrated view, the battery box 121 has been removed from the people mover 100. A battery surface 152 is illustrated. A battery can be removably fixed to the battery surface 152.

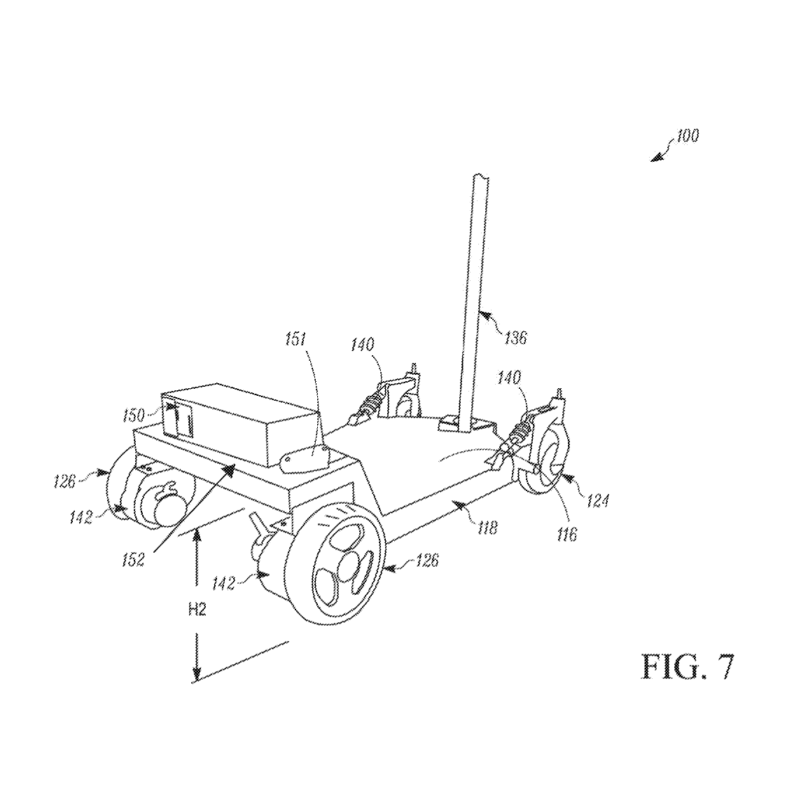

FIG. 7 illustrates a perspective view of the people mover of FIG. 5, according to some embodiments. In the illustrated view, the battery box 121 has been removed from the people mover 100. The battery surface 152 is illustrated and includes a battery 150 which is secured to the battery surface 152 via a battery mount 151. It will be appreciated that the battery mount 151 can removably secure the battery 150 to the battery surface 152. For example, the battery 150 may be removable for charging, for servicing (including replacement), or the like.

The people mover 100 includes electric motors 142. The electric motors 142 receive power from the battery 150 in order to proper the operator in a selected direction. Accordingly, the electric motors 142 are in communication with the controller 134 (FIG. 5). The electric motors 142 are individually controllable such that each of the rear wheels 126 can be operated individually to, for example, turn the people mover 100. The electric motors 142 can be variable speed motors such that the operator of the people mover 100 can select a speed for the people mover 100 during transit. The electric motors 142 are fixed to the frame 118.

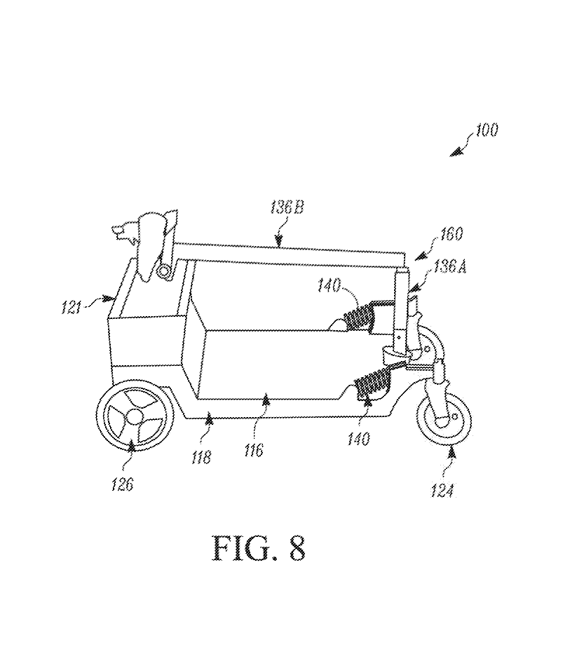

FIG. 8 illustrates a side view of the people mover 100 of FIG. 5, according to some embodiments. In the illustrated embodiment, the people mover 100 is folded into a transport configuration. In some embodiments, the transport configuration can alternatively be referred to as a storage configuration, or the like. It will be appreciated that the term “transport” or “storage” is not intended to be limiting. Generally, in the transport configuration the people mover 100 is not configured for operation. The transport configuration can, for example, enable the people mover 100 to be relatively more compact when not in use. The people mover 100 can be placed into the transport configuration as a result of a hinge assembly 160 on the support shaft 136. The support shaft 136 can be separated into two portions, a lower portion 136A and an upper portion 136B in order to enable rotation of the handle portion 114. In some embodiments, the hinge assembly 160 can have two locking positions. For example, the hinge assembly 160 can be locked into an operating configuration in which the lower portion 136A and the upper portion 136B extend in a same direction (e.g., so that the operator has the handle bars 130 in a configuration which allows the operator to operate the people mover). The hinge assembly 160 may also be locked into the transport configuration such that the handlebars 130 rest, for example, on a top surface of the battery box 121. In some embodiments, the hinge assembly 160 may have a single locking position, which locks the hinge assembly in the operating configuration. In some embodiments, the hinge assembly 160 an have more than two locking positions. In some embodiments, in the transport configuration, the upper portion 1369 of the support shaft 136 may be substantially parallel to the platform 116 of the people mover 100.

In some embodiments, the people mover 100 can additionally include one or more wheels (e.g., casters, etc.) which can be fixed to the frame 118 in a location near the electric motors 142 such that if the people mover 100 is lifted off of its front wheels the one or more wheels can prevent the electric motors 142 from directly contacting the ground.

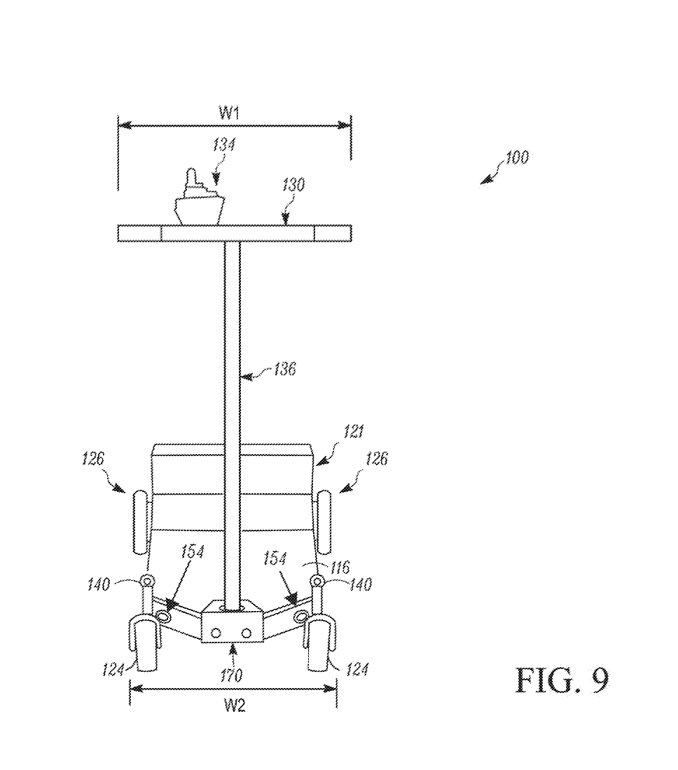

FIG. 9 illustrates a front view of the people mover 100 of FIG. 5, according to some embodiments. Headlights 154 are included on the base portion 112. The headlights 154 can be turned on or turned off via the controller 134, according to some embodiments. In some embodiments, the headlights 154 can be configured so that any time the people mover 100 is powered on, the headlights 154 are turned on and accordingly turned off any time the people mover 100 is powered off. It is to be appreciated that there can be one or more other lights on the people mover 100 such as, but not limited to, a brake light, a turn signal, or the like. The handlebars 130 have a width W1, which is generally wider than a width W2 of the front of the people mover 100. In some embodiments, the width W1 of the handlebars 130 can be between about 23 inches and about 24 inches. In some embodiments, the width W1 of the handlebars 130 can be at or about 23 inches. In some embodiments, the width W2 of the front of the people mover 100 can be between about 18 inches and about 20 inches. In some embodiments, the width W2 of the front of the people mover 100 can be between at or about 18.5 inches. It will be appreciated that these numbers are examples and that the widths W1 and W2 can vary beyond the stated values. It will be appreciated that in some embodiments, the width W1 and W2 can be about the same. In general, the width of the people mover 100 can be selected such that the people mover can fit within a standard door frame so that, for example, the operator can ride the vehicle through a doorway.

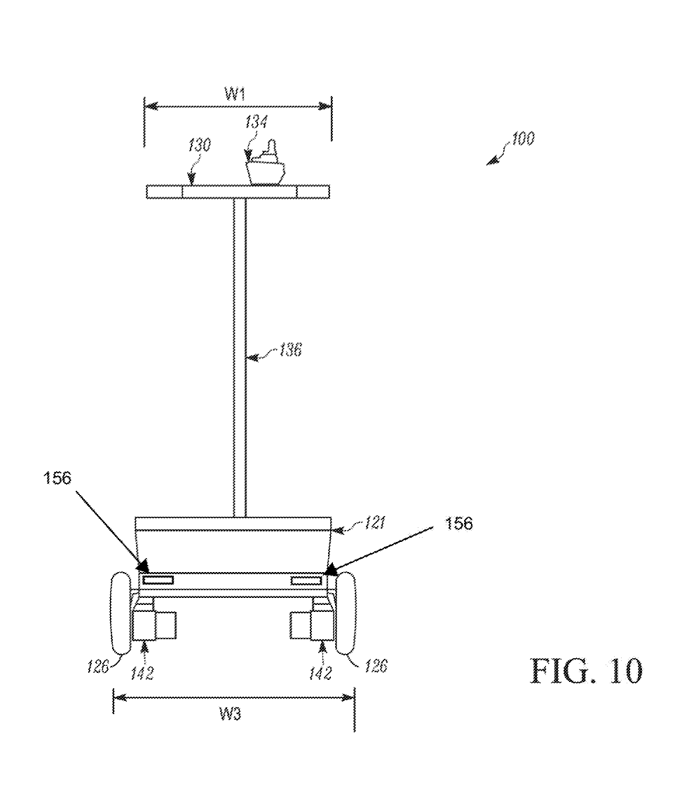

FIG. 10 illustrates a rear view of the people mover 100 of FIG. 5, according to some embodiments. The people mover 100 has a rear width W3. The rear width W3 can, in some embodiments, be a relatively widest part of the people mover 100. That is, the width W3 can be greater than the widths W1 and W2 described with reference to FIG. 9. In some embodiments, the rear width W3 can be between about 23.25 inches and about 27 inches. In some embodiments, the rear width W3 can be at or about 23.25 inches. It will be appreciated that this number is an example and can vary beyond the stated value. Additionally the rear of the people mover 100 can include one or more brake lights (e.g., brake lights 156), turn signals, or the like.

Aspects:

It is noted that any one of aspects 1-10 can be combined with any one of aspects 11, any one of aspects 12-15, any one of aspects 16-24, and aspect 25. Aspect 11 can be combined with any one of aspects 12-15, any one of aspects 16-24, and aspect 25. Any one of aspects 12-15 can be combined with any one of aspects 16-24 and aspect 25. Any one of aspects 16-24 can be combined with aspect 25.

Aspect 1. An electrical self-controlled individual people mover, comprising:
a base portion, the base portion including:
   a frame,
   a platform fixed to the frame, the platform having a support surface for supporting an operator standing thereon,
   a set of front wheels and a set of rear wheels, the front and rear wheels being disposed under the platform relative to a transport surface, and
   a shaft extending away from the transport surface;
a handle portion, the handle portion including:
   a handle bar for the operator to hold on to,
   a support shaft removably fixed to the shaft, the support shaft extending between the support surface of the platform and the handle bar, and
an electronic controller for navigating the people mover.

Aspect 2. The electrical self-controlled individual people mover according to aspect 1, wherein the set of front wheels is larger in diameter than the set of rear wheels.

Aspect 3. The electrical self-controlled individual people mover according to any one of aspects 1-2, wherein the electronic controller includes one or more of a speed controller, a direction controller, and a power switch controller.

Aspect 4. The electrical self-controlled individual people mover according to any one of aspects 1-3, wherein the electronic controller includes a joy-stick type direction controller.

Aspect 5. The electrical self-controlled individual people mover according to any one of aspects 1-4, further comprising one or more headlights.

Aspect 6. The electrical self-controlled individual people mover according to aspect 5, wherein the electronic controller includes a headlight controller.

Aspect 7. The electrical self-controlled individual people mover according to any one of aspects 1-6, further comprising:
first and second electric motors fixed to the frame, the first electric motor configured to rotate a first of the front wheels and the second electric motor configured to rotate a second of the front wheels, wherein the first and second electric motors are controllable by the electronic controller.

Aspect 8. The electrical self-controlled individual people mover according to aspect 7, further comprising:
third and fourth electric motors fixed to the frame, the third electric motor configured to rotate a first of the rear wheels and the fourth electric motor configured to rotate a second of the rear wheels, wherein the third and fourth electric motors are controllable by the electronic controller.

Aspect 9. The electrical self-controlled individual people mover according to any one of aspects 1-8, wherein the handle bar is adjustable relative to the support shaft such that a height of the handle bar is adjustable with respect to a distance from the support surface of the platform.

Aspect 10. The electrical self-controlled individual people mover according to any one of aspects 1-9, wherein the electronic controller is fixed to the handle bar.

Aspect 11. A method of manufacturing an electrical self-controlled individual people mover, the method comprising:
providing a base portion, the base portion including:
   a frame,
   a platform fixed to the frame, the platform having a support surface for supporting an operator standing thereon,
   a set of front wheels and a set of rear wheels, the front and rear wheels being disposed under the platform relative to a transport surface, and
   a shaft extending away from the transport surface;
providing a handle portion, the handle portion including:
   a handle bar for the operator to hold on to,
   a support shaft removably fixed to the shaft, the support shaft extending between the support surface of the platform and the handle bar, and
fixing an electronic controller for navigating the people mover.

Aspect 12. A method of operating an electrical self-controlled individual people mover, the method comprising:
stepping onto a platform of the people mover in a vertical standing position;
grasping a handle bar, the handle bar being removably fixed to a base portion of the people mover;
turning on an on/off switch controller on an electronic controller which is mounted to the handle bar;
setting a speed controller to a desired speed; and
moving a joystick to control a transport path of the people mover.

Aspect 13. The method according to aspect 12, further comprising:
turning on/off a headlight.

Aspect 14. The method according to any one of aspects 12-13, further comprising: slowing and/or stopping the people mover.

Aspect 15. The method according to aspect 14, further comprising:
stepping off the platform.

Aspect 16. An electrical self-controlled individual people mover, comprising:
a base portion, including:
   a frame,
   a platform fixed to the frame, the platform having a support surface for supporting an operator standing thereon, and
   a set of front wheels and a set of rear wheels;
a handle portion, including:
   a handle bar for the operator to hold on to,
   a shaft extending between the support surface of the platform and the handle bar, and
   an electronic controller for navigating the people mover.

Aspect 17. The electrical self-controlled individual people mover according to aspect 1, wherein the set of front wheels is smaller in diameter than the set of rear wheels.

Aspect 18. The electrical self-controlled individual people mover according to any one of aspects 16-17, wherein the electronic controller includes one or more of a speed controller, a direction controller, and a power switch controller.

Aspect 19. The electrical self-controlled individual people mover according to any one of aspects 16-18, wherein the electronic controller includes a joy-stick type direction controller.

Aspect 20. The electrical self-controlled individual people mover according to any one of aspects 16-19, further comprising one or more headlights.

Aspect 21. The electrical self-controlled individual people mover according to aspect 20, wherein the electronic controller includes a headlight controller.

Aspect 22. The electrical self-controlled individual people mover according to any one of aspects 16-21, further comprising:
first and second electric motors fixed to the frame, the first electric motor configured to rotate a first of the rear wheels and the second electric motor configured to rotate a second of the rear wheels, wherein the first and second electric motors are controllable by the electronic controller.

Aspect 23. The electrical self-controlled individual people mover according to any one of aspects 16-22, wherein the handle bar is adjustable relative to the support surface such that a height of the handle bar is adjustable with respect to a distance from the support surface of the platform.

Aspect 24. The electrical self-controlled individual people mover according to any one of aspects 16-23, wherein the electronic controller is fixed to the handle bar.

Aspect 25. A method of manufacturing an electrical self-controlled individual people mover, the method comprising:
providing a base portion, including:
   a frame,
   a platform fixed to the frame, the platform having a support surface for supporting an operator standing thereon, and
   a set of front wheels and a set of rear wheels;
providing a handle portion, including:
   a handle bar for the operator to hold on to,
   a shaft extending between the support surface of the platform and the handle bar, and
fixing an electronic controller to the handle bar for navigating the people mover.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed, and the shape, size, and arrangement of parts without departing from the scope of the present disclosure. This specification and the embodiments described are examples only, with the true scope and spirit of the disclosure being indicated by the claims that follow.

What is claimed is:

1. An electrical self-controlled individual people mover, comprising:
a base portion, the base portion including:
a frame,
a platform fixed to the frame, the platform having a support surface for supporting an operator standing thereon, and
a set of front wheels and a set of rear wheels, one of the set of front wheels or the set of rear wheels being connected to an electric motor for each wheel of the set of front wheels or the set of rear wheels, the electronic motors for powering the electrical self-controlled individual people mover;
a handle portion, the handle portion including:
a handle bar for the operator to hold on to,
a support shaft removably fixed to the shaft, the support shaft extending between the support surface of the platform and the handle bar, and
an electronic controller for navigating the people mover.

2. The electrical self-controlled individual people mover according to claim 1, wherein the set of front wheels and the set of rear wheels have different diameters from each other.

3. The electrical self-controlled individual people mover according to claim 1, wherein the electronic controller includes one or more of a speed controller, a direction controller, and a power switch controller.

4. The electrical self-controlled individual people mover according to claim 1, wherein the electronic controller includes a joy-stick type direction controller.

5. The electrical self-controlled individual people mover according to claim 1, further comprising one or more headlights.

6. The electrical self-controlled individual people mover according to claim 5, wherein the electronic controller includes a headlight controller.

7. The electrical self-controlled individual people mover according to claim 1, wherein the electric motors are fixed to the frame, a first of the electric motors configured to rotate a first of the rear wheels and a second of the electric motors configured to rotate a second of the rear wheels, wherein the first and second electric motors are controllable by the electronic controller.

8. The electrical self-controlled individual people mover according to claim 1, wherein the electric motors are fixed to the frame, a first of the electric motors configured to rotate a first of the front wheels and a second of the electric motors configured to rotate a second of the front wheels, wherein the first and second electric motors are controllable by the electronic controller.

9. The electrical self-controlled individual people mover according to claim 1, wherein the handle bar is adjustable relative to the support shaft such that a height of the handle bar is adjustable with respect to a distance from the support surface of the platform.

10. The electrical self-controlled individual people mover according to claim 1, wherein the electronic controller is fixed to the handle bar.

11. The electrical self-control led individual people mover according to claim 1, wherein the support shaft includes an upper portion and a lower portion, a hinge assembly connecting the upper and lower portions.

12. The electrical self-controlled individual people mover according to claim 11, wherein the hinge assembly is configured such that the upper portion can be rotated such that the handle bar is disposed in a transport configuration in which the upper portion of the support shaft is disposed substantially parallel to the support surface.

13. The electrical self-controlled individual people mover according to claim 1, further comprising a shock absorbing device for each wheel of the set of front wheels.

14. The electrical self-controlled individual people mover according to claim 13, wherein the shock absorbing device includes an adjustable stiffness.

15. A method of manufacturing an electrical self-controlled individual people mover, the method comprising:
providing a base portion, the base portion including:
a frame,
a platform fixed to the frame, the platform having a support surface for supporting an operator standing thereon, and
a set of front wheels and a set of rear wheels, one of the set of front wheels or the set of rear wheels being connected to an electric motor for each wheel of the set of front wheels or the set of rear wheels, the electronic motors for powering the electrical self-controlled individual people mover;
providing a handle portion, the handle portion including:
a handle bar for the operator to hold on to,
a support shaft removably fixed to the shaft, the support shaft extending between the support surface of the platform and the handle bar, and
fixing an electronic controller for navigating the people mover.

16. A method of operating an electrical self-controlled individual people mover, the method comprising:
stepping onto a platform of the people mover in a vertical standing position;
grasping a handle bar, the handle bar being removably fixed to a base portion of the people mover;
turning on an on/off switch controller on an electronic controller which is mounted to the handle bar;
setting a speed controller to a desired speed; and
moving a joystick to control a transport path of the people mover.

17. The method according to claim 16, further comprising:
turning on/off a headlight.

18. The method according to claim 16, further comprising:
slowing and/or stopping the people mover.

19. The method according to claim 18, further comprising:
stepping off the platform.
